(19) United States
(12) Patent Application Publication
(10) Pub. No.: US 2022/0129381 A1
(43) Pub. Date: Apr. 28, 2022

(54) BLOCKCHAIN CACHE SYSTEM

(71) Applicant: Planaria Corp., New York, NY (US)

(72) Inventor: Changu Kang, New York, NY (US)

(21) Appl. No.: 17/518,279

(22) Filed: Nov. 3, 2021

Related U.S. Application Data
(63) Continuation of application No. PCT/US2020/032507, filed on May 12, 2020.
(60) Provisional application No. 62/847,591, filed on May 14, 2019.

(51) Int. Cl. G06F 12/0802

(52) U.S. Cl. CPC G06F 12/0802; G06F 2212/60

(57) ABSTRACT

The present disclosure provides systems, methods, and computer program products for obtaining data from a blockchain. An example system may comprise a cache engine comprising cache storage and a blockchain crawler. The blockchain crawler may be configured to obtain blockchain data from the blockchain and write a subset of the blockchain data to the cache storage. The subset of the blockchain data may satisfy a query generated by the cache engine. The system may further comprise a blockchain query service communicatively coupled to the cache engine. The blockchain query service may comprise state storage and a cache crawler. The cache crawler may be configured to obtain cache data from the cache storage and update a state of the state storage based at least on the cache data.

### CROSS-REFERENCE

This application is a continuation application of International Application No. PCT/US2020/32507, filed on May 12, 2020, which claims priority to U.S. Provisional Patent Application No. 62/847,591, filed on May 14, 2019, which applications are entirely incorporated herein by reference.

### BACKGROUND

A blockchain is a list of data blocks that are linked using cryptography. Each block may contain a hash of the previous block in the list, a timestamp, and transaction data. In order to alter data in a particular block, all subsequent blocks in the blockchain may need to be altered, which may require a consensus of such subsequent blocks. For this reason, blockchains may be a desirable medium in which to securely store data. However, blockchains may not be optimized for querying. While blockchain software may include built-in query mechanisms such as JavaScript Objection Notation-RPC (“JSON-RPC”), such mechanisms may be primitive and only provide limited ways to query the blockchain. For example, it may not be possible to aggregate or filter blockchain transactions. Also, while such primitive query mechanisms may allow one to retrieve immediately-available datasets supported by the blockchain's own data structure, it may not be possible to query for datasets computed or derived from the blockchain as a second layer state machine. The level of throughput provided by the available query mechanisms may also be low and may sometimes cause blockchain software to crash, which may result in blockchain nodes going offline to re-index. Re-indexing may take hours or days or weeks depending on the host machine and the severity of the crash. During this time, the blockchain cannot be used for production.

### SUMMARY

The present disclosure provides systems, methods, and computer program products for obtaining data from a blockchain. The systems described herein may have blockchain query services and a separate cache engine. The cache engine can obtain data directly from the blockchain by crawling the blockchain and writing such data to storage in an indexed format. Thereafter, the cache engine can replicate the data or broadcast the data to other cache engines. The cache engine can also make the data available to the blockchain query services.

Implementing the blockchain query services and the cache engine separately may confer numerous advantages. Separating the two components may minimize the number of direct queries into the blockchain, which may reduce network bandwidth requirements and the likelihood of the blockchain crashing. Separating the two components may also reduce the latency of blockchain queries. Existing blockchain query services may need to scrape the entire blockchain directly to update their states and respond to requests from applications, even if only a small subset of blockchain data is actually required to fulfill those requests. This process may introduce unnecessary latency. In contrast, the cache engine described herein can store blockchain data in an indexed format that is conducive to querying. By indexing blockchain data, the cache engine can make the blockchain data more quickly and easily available to many different types of blockchain query services.

In one aspect, the present disclosure provides a method for obtaining blockchain data. The method may comprise providing a blockchain system comprising (i) a cache engine comprising cache storage and a blockchain crawler and (ii) a blockchain query service communicatively coupled to the cache engine. The blockchain query service may comprise state storage and a cache crawler. The method may further comprise using the blockchain crawler to obtain blockchain data from the blockchain and write a subset of the blockchain data to the cache storage or update a state of the cache storage based on the subset of the blockchain data. The subset of the blockchain data may satisfy a query generated by the cache engine. The method may further comprise using the cache crawler to obtain cache data from the cache storage and update a state of the state storage based at least on the cache data.

In some embodiments, the subset of the blockchain data comprises all of the blockchain data. In some embodiments, the blockchain query service comprises a server, and the method further comprises using the server to communicate the state of the state storage to one or more applications. In some embodiments, the blockchain query service does not obtain data directly from the blockchain. In some embodiments, (c) comprises obtaining the cache data from the cache storage by transmitting a query request or a subscription request to the cache engine. In some embodiments, the query is based at least in part on the query request or the subscription request from the blockchain query service. In some embodiments, the query is based at least in part on a current state of the cache storage. In some embodiments, the query specifies a plurality of blocks in the blockchain to obtain. In some embodiments, the method further comprises using the cache engine to transmit a cache update event upon writing the subset of the blockchain data to the cache storage. In some embodiments, the query is a one-time query. In some embodiments, the query is a subscription. In some embodiments, the subscription comprises a condition that upon satisfaction causes the blockchain crawler to obtain data from the blockchain. In some embodiments, the condition comprises a time or a frequency. In some embodiments, the condition comprises an event on the blockchain. In some embodiments, (b) comprises writing the subset of the blockchain data to the cache storage in an indexed format. In some embodiments, the indexed format is a file system, a database, or in-memory storage. In some embodiments, the blockchain crawler comprises a state transition engine, wherein the state transition engine writes the subset of the blockchain data to the cache storage. In some embodiments, (b) comprises using the state transition engine to normalize, encode, decode, serialize, deserialize, transform, or filter the blockchain data to generate the subset of the blockchain data. In some embodiments, the cache storage is configured to store at most a subset of the entire contents of the blockchain. In some embodiments, the method further comprises pruning blockchain data from the cache storage that corresponds to transactions that occurred outside a specified time frame. In some embodiments, the blockchain query service is one of a plurality of blockchain query services, and wherein each of the plurality of blockchain query services in communicatively coupled to the cache. In some embodiments, the plurality of blockchain query services do not obtain data directly from the blockchain. In some embodiments, the method further comprises providing a plurality of additional cache engines, wherein the plurality of additional cache engines do not comprise a blockchain crawler; and writing, using the blockchain crawler of the cache engine, the subset of the blockchain data to the plurality of additional cache engines. In some embodiments, each of the plurality of additional cache engines is communicatively coupled to at least one additional blockchain query service. In some embodiments, the method further comprises providing an additional cache engine, wherein the blockchain query service is communicatively coupled to the additional cache engine. In some embodiments, the additional cache engine comprises an additional cache storage, and wherein the cache storage and the additional cache storage store the same data. In some embodiments, the additional cache engine comprises an additional cache storage, and wherein the cache storage and the additional cache storage store different data. In some embodiments, the method further comprises providing a cache registry, wherein the cache registry is communicatively coupled to the cache engine; and storing metadata about the cache engine in the cache registry, wherein the metadata about the cache engine is accessible by a plurality of blockchain query services including the blockchain query service. In some embodiments, the metadata comprises a unique identifier of the cache engine. In some embodiments, the metadata defines a type of service provided by the cache engine.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 schematically illustrates a blockchain query service;

FIG. 2 schematically illustrates a blockchain cache system;

FIG. 3 schematically illustrates a blockchain cache system that is multiplexed to serve multiple blockchain query services;

FIG. 4 illustrates a blockchain cache system that is multiplexed to serve multiple other blockchain cache systems;

FIG. 5 schematically illustrates a blockchain crawler that is multiplexed to serve multiple cache engines;

FIG. 6 schematically illustrates a blockchain query service that connects to multiple cache engines;

FIG. 7 schematically illustrates a cache registry system;

FIG. 8 is a flow chart of a process for crawling a blockchain;

FIG. 9 is a flow chart of a process for listening to a blockchain;

FIG. 10 is a flow chart of a process for interfacing with a client;

FIG. 11 is a flow chart of a process for crawling a cache engine;

FIG. 12 is a flow chart of a process for listening to a cache engine;

FIG. 13 schematically illustrates an alternative embodiment of the blockchain cache system of FIG. 2; and

FIG. 14 schematically illustrates a computer system that is programmed or otherwise configured to implement methods provided herein.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

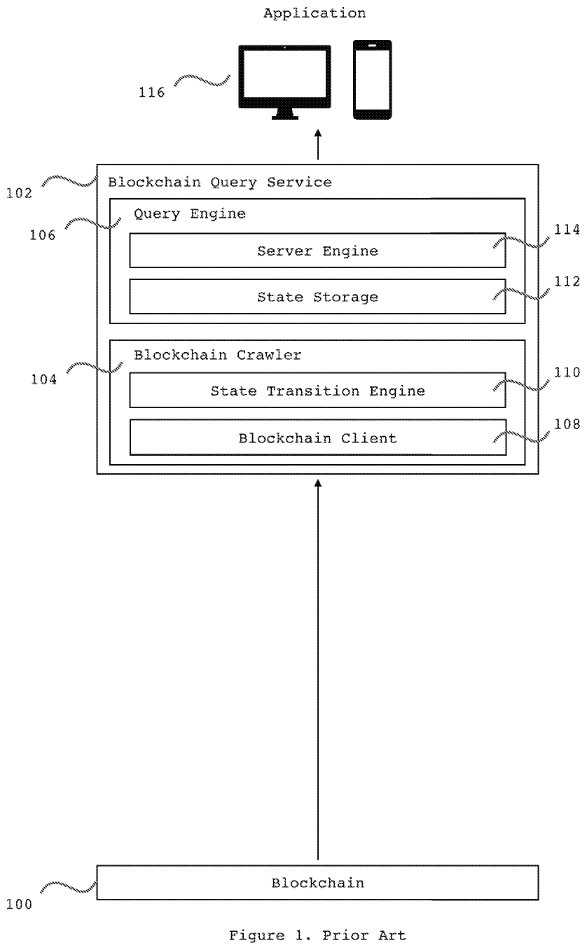

FIG. 1 illustrates a blockchain query service 102. The blockchain query service 102 may have a blockchain crawler 104 and a query engine 106. The blockchain crawler 104 may have a blockchain client 108 and a state transition engine 110. The blockchain crawler 104 may communicate with a blockchain 100 via the blockchain client 108 in order to crawl the data in the blockchain 100 and populate state storage 112 of the query engine 106. The crawling may be performed by the blockchain client 108. To crawl the blockchain 100, the blockchain client 108 may make requests (e.g., JavaScript Objection Notation-RPC (“JSON-RPC”) requests) to an application programming interface (“API”) associated with the blockchain 100, directly access the file system of the blockchain 100, or the like. The process may be referred to as “crawling” as a reference to web crawlers widely used in web search engines to collect and extract data from the Internet. A blockchain crawler may be similar to a web crawler, but a blockchain crawler may crawl a blockchain's data structure chronologically (e.g., by fetching data from blocks 1, 2, 3, and 4 chronologically) instead of through various methods typically employed by web crawlers. Just as web crawlers seek to analyze and index every meaningful aspect of Internet data, the blockchain crawler 104 may collect every piece of data available from the blockchain 100.

All of these pieces of data can be indexed in various ways. Furthermore, the blockchain data may even be used to construct an entirely different type of virtual database or a storage system. For example, instead of storing the raw blockchain data, the blockchain query service 102 may implement certain rules which dictate how new blockchain transactions should be interpreted and stored. And following this rule set, it may be possible to operate a full-fledged state machine by using blockchain data as input. This approach may enable the creation of a mutable database. For example, the blockchain query service 102 can implement a state machine that can process transactions that include commands such as “+1”, “+2”, “−1”, and “+3”. The state machine can maintain a state of “5” as the result of such commands. This is an interesting usage of the blockchain because while the blockchain itself is an immutable storage, the blockchain query service 102 can utilize the immutable data set to power a mutable storage, as just explained. Once the data becomes available through crawling, the blockchain query service may implement a query interface to this new storage so that external clients and applications 116 can consume data from the query service.

After the blockchain client 108 fetches data from blockchain 100, it can pass the data to the state transition engine 110, which can process the data according to pre-programmed logic. In addition to using the data extracted from the blockchain client 108, the state transition engine 110 can utilize the current contents of the state storage 112 to decide how to update the state storage 112.

The workflow spanning from blockchain 100 to state storage 112 can be executed on-demand, or based on listening to real-time events from the blockchain 100. For example, the blockchain client 108 can listen to all the system events (e.g., ZeroMQ® messages) emitted by blockchain 100 and trigger the blockchain crawling process described above. Once the state storage 112 is populated and available, the server engine 114 can connect to the state storage 112 to provide a query service to an external application 116. When the application 116 needs to query the blockchain, instead of directly querying the blockchain 100, it can query the blockchain service 102. To do that, the application 116 can connect to the server engine 114 and send a request. The server engine 114 can interpret the request, perform a query of the state storage 112, and return the response.

The blockchain query service 102 of FIG. 1 may have certain limitations. Because blockchain query services of this type may scrape data directly from blockchains to maintain their states, the interface between such query services and a particular blockchain may form a bottleneck, particularly when such query services simultaneously connect to and synchronize from one blockchain node instance. One way to address this problem is to add additional instances of the blockchain node software in order to spread out the request load per blockchain node. However, this may be inefficient.

First, to create an additional instance of the blockchain node software, the blockchain query service may need to store the entire state history of the blockchain, beginning from block 1. This may require a significant amount of memory, and only a small subset of data stored in the memory may be of interest. Second, the blockchain node software may need to synchronize with the blockchain query service over a network at all times, which may not be scalable due to network bandwidth constraints. For example, 1 terabyte of network bandwidth would be required to synchronize 1000 instances of a 1 gigabyte (“GB”) blockchain node.

Blockchain query services like the blockchain query service 102 of FIG. 1 may have additional limitations. For example, they may have only limited ways of retrieving data from the blockchain, such as crawling the blockchain through a built-in JSON-RPC API, reading local blockchain files directly, or through directly making peer to peer data requests to the connected blockchain peers. The limitation with respect to locally reading the blockchain files is that this method may only be used locally on a single machine. A blockchain query service may not be able to use this method to retrieve data from remote blockchain instances. With respect to built-in query methods that use JSON-RPC, there are protocols such as HTTP2 which are more performant at scale because they perform multiplexing (e.g., combining signals in a single transmission medium) and HTTP2 server push. There are also peer-to-peer replication methods such as IPFS, BitTorrent, and DAT which can offload the replication to all the seeders in the network. But blockchain software generally does not use such protocols because using such protocols may compromise the security of the blockchain.

Another limitation of existing blockchain query services is that a particular blockchain query service may store data in a format that facilitates the particular function that that blockchain query service performs, but not other functions or verification. For example, if the blockchain query service 102 is a state machine that provides a counter service that increments its counter for every new transaction, the blockchain query service 102 may store only the counter in its state storage 112, rather than keeping track of all the events that have happened on the blockchain and reconstructing the counter every time application 116 makes a query. This may be efficient for third-party applications that query the blockchain query service, but it may not be easy to verify the authenticity of the dataset. Verifying the authenticity of the current state may require re-crawling the blockchain 100, reconstructing the counter, and comparing it with the current state of the state storage 112.

In some cases, the function of the blockchain query service may involve money, in which case verification and authenticity are particularly important. For example, a blockchain query service may implement a token system. The tokens may be state machines that operate based on various blockchain transaction patterns and make state transitions that indicate token transfers or other important actions. The state machines may exist outside of the blockchain in the form of the blockchain query service 102. As such, token transfers may not be validated by the miners of the blockchain network. Instead, the validation may be virtual and may be constructed by crawling the blockchain. Because authenticity is not enforced by the blockchain miners directly but by the protocol that runs the blockchain query service 102, customers of the token system may want to ensure that the current state of the token system (implemented as the blockchain query service 102) is accurate and actually corresponds to the state of the blockchain.

As a result, re-crawling of the blockchain may become more frequent, and the problem of load balancing on the blockchain may become more severe. For example, law enforcement may require each such blockchain query service to re-crawl the blockchain to verify authenticity. Or the blockchain query services may want to constantly execute the re-crawls to detect and minimize errors. In this case, re-crawling the blockchain from the beginning of the state machine's birth for every block may put too much burden on the blockchain software 100.

Another limitation of existing blockchain query services is that each blockchain query service may be centralized around the blockchain instance it connects to. Such a blockchain instance may be a central point of failure. And because all the blockchain query services must connect directly to the source blockchain instance, these blockchain query services may lose connection to their source blockchain and stop updating during certain edge cases such as a network partition, even when the blockchain itself is up and running. The lack of a low cost off-chain replication method for blockchain data makes the whole architecture and ecosystem of the blockchain query service unreliable and not scalable.

Another limitation of existing blockchain query services is that systems for storing data and systems for serving data do not necessarily require the same qualities. For example, existing cloud archival solutions such as Amazon Glacier may have a different design than file delivery services such as Amazon S3. The Amazon Glacier system may be designed for archiving whereas S3 may be designed for end-user consumption. Consequently, S3 may be optimized for high performance loading of data whereas Glacier may be optimized for low storage cost. By having both features bundled into a single system, as existing blockchain query services do, it may be difficult to optimize the system for both purposes. The current state of the art for the aforementioned blockchain query services is a fixed architecture where both archiving and serving features are bundled as a single system. This may be difficult to optimize.

The above-mentioned limitations did not render blockchain query services inoperable for early blockchains because the use of blockchains as data ledgers was initially discouraged due to their low throughput. For example, Bitcoin (BTC) can only store 1 megabyte (“MB”) to 4 MB of transaction data in a single block. However, newer blockchain networks may be optimized for scaling and for use as data ledgers, which may exacerbate the limitations mentioned above. Therefore, it may be desirable to have a modular blockchain cache and replication system such that direct queries into the blockchain are minimized, and the cost of storing and replicating blockchain-derived data goes down significantly.

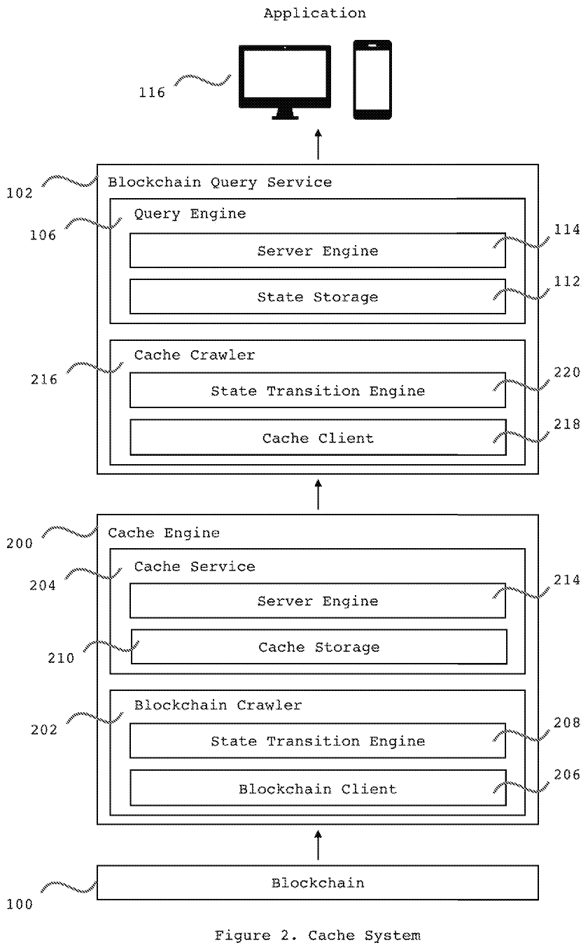

FIG. 2 schematically illustrates a blockchain cache system, according to one embodiment. The blockchain cache system may have a blockchain query service 102 and a cache engine 200. The cache engine 200 may have a blockchain crawler 202 and a cache service 204. The blockchain query service may employ a cache crawler 216 in place of the blockchain crawler 104 of FIG. 1. The cache crawler 216 can interface with the cache engine 200, rather than crawling the blockchain 100 directly. The cache crawler 216 can interface with the cache engine 200 through cache client 218 to fetch data from the cache engine 200.

The cache engine 200 can utilize the blockchain crawler 202 to crawl data from the blockchain 100 and populate it into the cache service 204. The blockchain crawler 202 can include a blockchain client 206 and a state transition engine 208. The blockchain crawler 202 of the cache engine 200 may be similar to and perform similar functions as the blockchain crawler 104 of the blockchain query service 102 from FIG. 1. The blockchain crawler 202 can connect directly to the blockchain 100 and extract data from it. The crawling action may be performed using a built-in blockchain API such as JSON-RPC, but it may additionally or alternatively be performed by directly accessing the local blockchain file system, or by any other existing means.

The blockchain crawler 202 can send the extracted data to the state transition engine 208, which can use the data to update the cache storage 210 based on pre-programmed logic. The pre-programmed logic may include logic that implements data normalization, encoding, decoding, serialization, deserialization, transformation, filtering, and the like. The cache storage 210 can be implemented as a file system, a database (e.g., relational database, document database, graph database, key-value database, etc.), in-memory storage, or the like. For example, if the cache storage 210 is implemented as a file system, updating it may involve creating, updating, moving, or deleting files. If cache storage 210 is implemented as a database, the state transition engine 208 can execute a database insertion, update, or deletion. If cache storage 210 is implemented as in-memory storage, the state transition engine 208 can create, update, or delete various in-memory variables in a program. The state transition engine 208 may also utilize the existing contents of the cache storage 210 to make decisions about how to update the state of the cache storage 210. The data in the cache storage 210 can be indexed in various ways to make it quickly and easily accessible to the blockchain query service 102.

The cache storage 210 can store a subset of the blockchain 100. The subset may comprise blockchain transactions that occurred within a specified time frame, e.g., the last hour, the last 5 hours, the last 10 hours, the last 24 hours, the last 48 hours, or the like. The state transition engine 208 can prune transactions from the cache storage 210 that are outside the specified time frame to make room for new transactions. This may ensure that queries of the cache storage 210 return deterministic results. Alternatively or additionally, the subset may comprise blockchain transactions that meet certain conditions or criteria.

Once the cache storage 210 is populated and available, it can be served to external clients through the cache service 204. The cache service 204 may include the cache storage 210, whose state management is maintained by the state transition engine 208. The cache service 204 may also include a server engine 214, which can expose the cache service 204 to external clients. The cache client 218 can connect to the cache service 204 through the server engine 214 and send a request, describing what kind of data it is looking for. The server engine 214 can then deliver the relevant data from the cache storage 210 to the cache client 218. The cache client 218 then can send the data to the state transition engine 220, which can programmatically update the state storage 112 of the blockchain query service 102. The mode of data transmission may be pull-based or push-based. For example, the cache client 218 can continually send requests (i.e., pulls) to the server engine 214, or it can send an initial one-time request, after which the server engine 214 can push data to the cache client 218 that meets the initial request. The blockchain query service 102 can now source its data from the cache engine 200 through the cache crawler 216, instead of sourcing the data directly from the blockchain 100 through blockchain crawler 104 (FIG. 1). The blockchain query service 102 may be designed in such a way that the cache crawler 216 and the blockchain crawler 104 may be switched back and forth interchangeably. Indexing and storing blockchain data in a centralized location as described above may be considered unconventional because blockchains traditionally have a decentralized tree-structure.

The components of FIG. 2 may be implemented on one or more computing devices in one or more locations. The computing devices can be servers, desktop or laptop computers, electronic tablets, mobile devices, or the like. The computing devices can be located in one or more locations. The computing devices can have general-purpose processors, graphics processing units (GPU), application-specific integrated circuits (ASIC), field-programmable gate-arrays (FPGA), or the like. The computing devices can additionally have memory, e.g., dynamic or static random-access memory, read-only memory, flash memory, hard drives, or the like. The memory can be configured to store instructions that, upon execution, cause the computing devices to implement the functionality of the subsystems. The computing devices can additionally have network communication devices. The network communication devices can enable the computing devices to communicate with each other and with any number of user devices, over a network. The network can be a wired or wireless network. For example, the network can be a fiber optic network, Ethernet® network, a satellite network, a cellular network, a Wi-Fi® network, a Bluetooth® network, or the like. In other implementations, the computing devices can be several distributed computing devices that are accessible through the Internet. Such computing devices may be considered cloud computing devices.

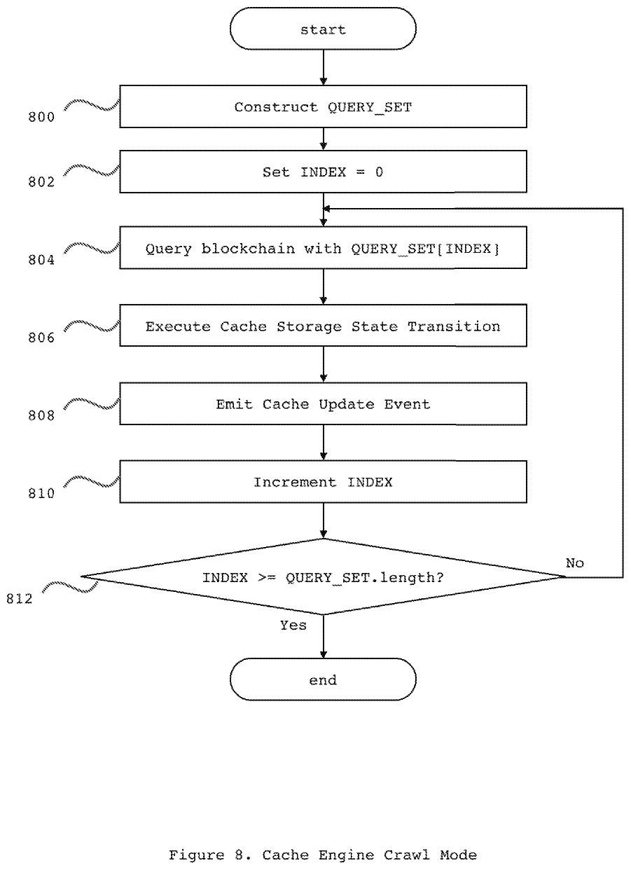

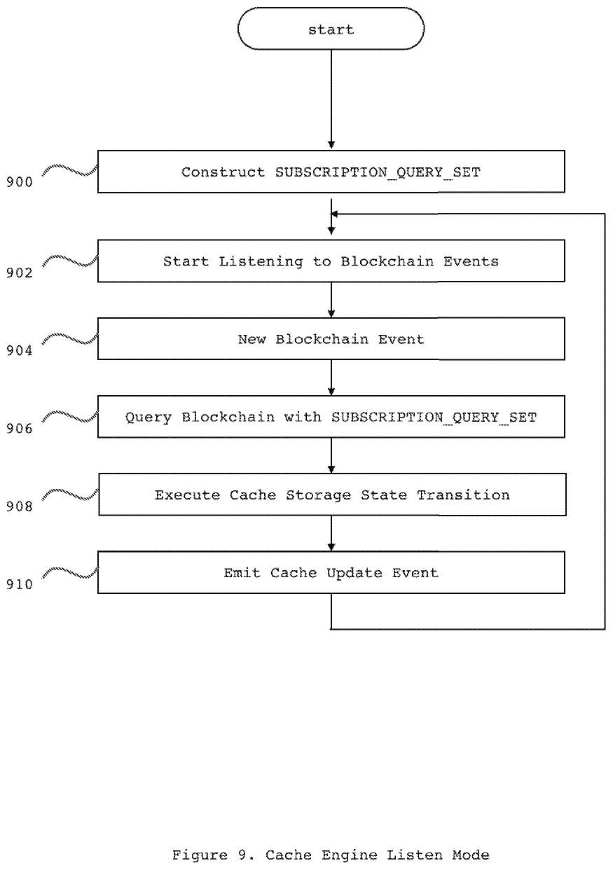

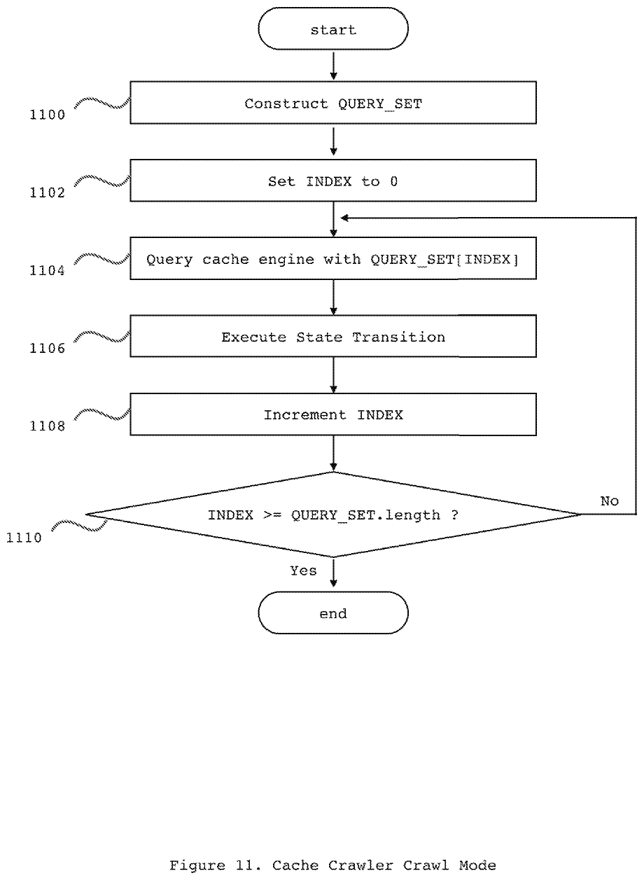

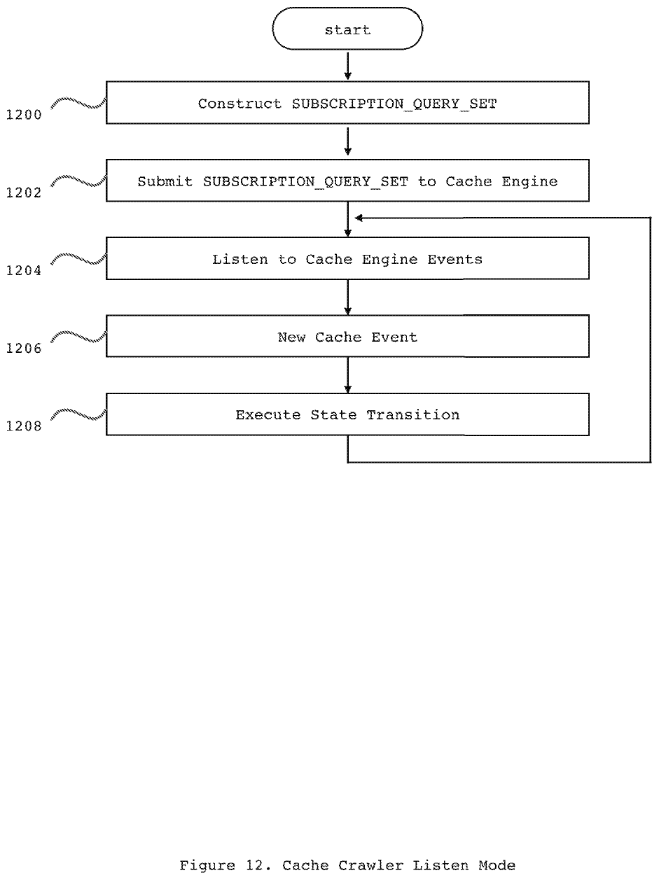

The cache engine 200 and the cache crawler 216 may have two modes of operation: “crawl mode” and “listen mode.” The cache engine 200 may be in crawl mode (FIG. 8) or in listen mode (FIG. 9) at any moment of operation. The cache crawler 216 may also be in crawl mode (FIG. 11) or listen mode (FIG. 12) at any moment of operation.

When the cache engine 200 is in crawl mode (FIG. 8), it can iterate through a set of queries in order to crawl and store data from a blockchain in the cache storage 210. When the cache engine 200 is in listen mode (FIG. 9), it can start an event loop that listens to any event from the blockchain, and only executes state transitions to the cache storage 210 when it detects a relevant event, instead of proactively iterating through the blockchain.

FIG. 8 is a flow chart of an example process for crawling the blockchain 100 from block X to block Y. The process may be performed by the cache engine 200 of FIG. 2 during crawl mode. The blockchain client 206 can construct a QUERY_SET, which may specify that the blockchain crawler 202 should “crawl all blocks from X until Y” (800). The blockchain client 206 can construct the QUERY_SET in several different ways. The blockchain client 206 may, for example, create an array of integers ranging from X until Y (e.g., [X, X+1, X+2, . . . , Y]). The QUERY_SET may be implemented in a query language such as MongoDB, JQ, or Bitquery. The QUERY_SET may be statically specified by the cache engine 200. Additionally or alternatively, the QUERY_SET may be dynamically generated programmatically. The QUERY_SET may also be based on a request from a third-party external client that connects to the cache engine 200, e.g., a query from the blockchain query service 102. For example, the blockchain service 102 may query the cache engine 200 and find that the data it needs is not available in the cache storage 210, or that such data is not sufficiently up-to-date. In such cases, the QUERY_SET may specify the data that is not available or not sufficiently up-to-date. The QUERY_SET may not be limited to block heights, but also may also specify other factors, including various aspects of the blockchain such as transaction push data patterns or various blockchain metadata. One example may be an array of blockchain transaction IDs.

Once the QUERY_SET is constructed, the blockchain client 206 can set the INDEX of the QUERY_SET to 0 (802) and begin reading from the blockchain 100 using the query instruction QUERY_SET[INDEX] (804). When the blockchain data for the query is successfully fetched, the blockchain client 206 can send the data to the state transition engine 208. The state transition engine 208 can process the incoming data with its pre-programmed logic and update the cache storage 210 accordingly (806).

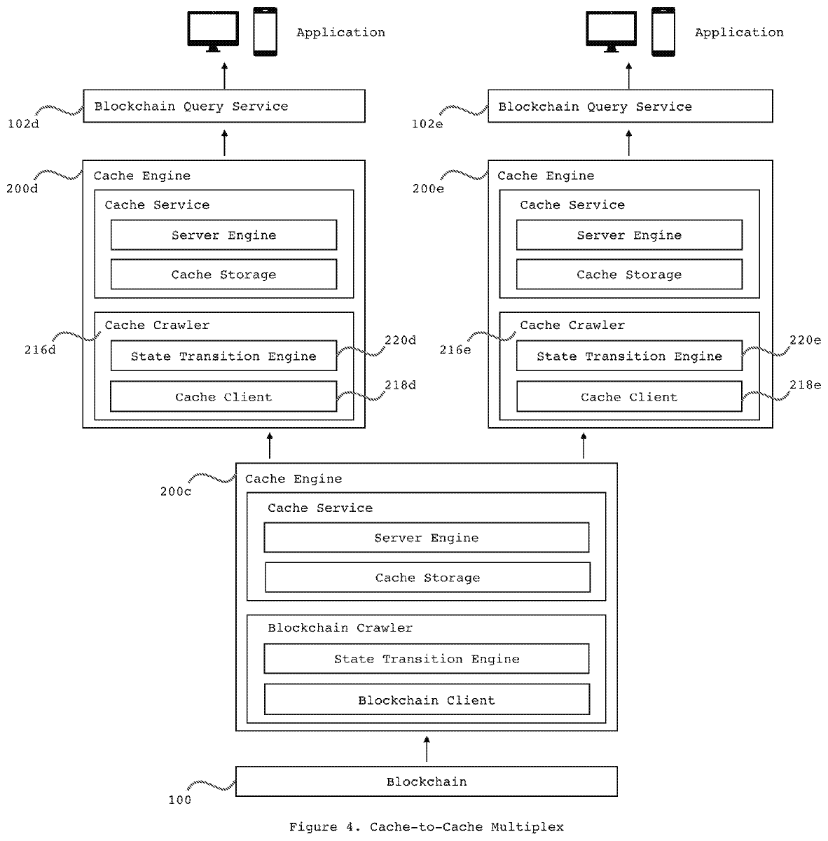

The cache engine 200 can then emit a cache update event (808) in case other components such as another cache client 218d (FIG. 4) are listening for further replication. After emitting the cache event update, the blockchain client 206 can increment the INDEX to INDEX+1 (810) and ensure that the QUERY_SET has not been fully iterated through by checking whether the INDEX is greater than or equal to the length of the QUERY_SET (812). If INDEX is not greater than or equal to the length of the QUERY_SET, the blockchain client 206 can query the blockchain 100 using the instruction QUERY_SET[INDEX+1] (804). If, on the other hand, the INDEX is greater than or equal to the length of the QUERY_SET, the crawling is complete. Thereafter, the cache engine 200 may halt or enter a listen mode (FIG. 9).

The cache client 218 of the cache crawler 216 can crawl the cache storage 210 in a similar manner. This will be described in greater detail in FIG. 11.

FIG. 9 is a flow chart of an example process for listening to the blockchain 100. The process can be performed by the blockchain client 206, which can be persistently connected and listening to the blockchain 100. The blockchain client 206 may listen for relevant events pushed to it from the blockchain 100. This is in contrast to the crawl mode (FIG. 8) where the blockchain client 206 proactively queries the blockchain 100 by iterating through a loop and halts once the iteration is finished.

The blockchain client 206 can construct a SUBSCRIPTION_QUERY_SET (900). The SUBSCRIPTION_QUERY_SET may be a set of conditions the cache client 218 has requested that the blockchain client 206 subscribe to. The set of conditions may include transactions that match certain data patterns (e.g., a certain byte sequence) or transactions that belong to a certain blockchain block, for example. The set of conditions may be a static set of conditions that are built-in or programmable by the server engine 214 of the cache service 204. Additionally or alternatively, the SUBSCRIPTION_QUERY_SET may be dynamically generated based on pre-programmed logic.

The blockchain client 206 can listen to events from the blockchain 100 (902). Unlike the crawl mode where it continuously crawls the blockchain by incrementing the index (810) until it has finished iterating through the entire QUERY_SET (812), the listen mode only triggers the crawling action when certain events happen (904). When a new blockchain event happens, the blockchain client 206 of the cache engine 200 can detect the event and query the blockchain 100 with the SUBSCRIPTION_QUERY_SET constructed in operation 900 (906). If there has been an update on the blockchain 100 that meets the set of conditions defined by the SUBSCRIPTION_QUERY_SET, the blockchain client 206 can send the data to the state transition engine 208, which can process the data and update the cache storage 210 accordingly (908). Then, the cache engine 200 can emit a cache update event (910). The blockchain client 206 of the cache engine 200 may then continue to listen for new blockchain events (902). The SUBSCRIPTION_QUERY_SET may be a condition that listens to every event, in which case the additional step of querying (906) may not be required, and the system can simply pass the event data directly to the state transition engine (908). The use of a subscription may reduce the time it takes the blockchain query service 102 to respond to a request from the application 116, because the response data may be readily available in the cache storage 210, which can be easily queried, rather than in the blockchain 100.

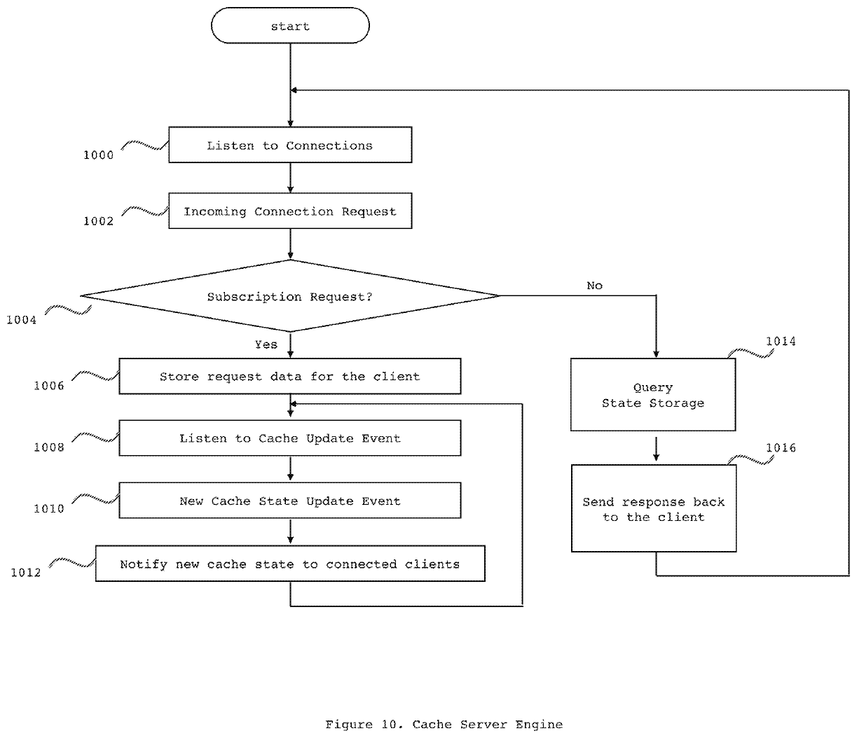

FIG. 10 is a flow chart of an example process performed by the cache server engine 214 for interfacing with a client. Once the cache storage 210 is populated, it can be exposed to external clients through the server engine 214. The cache server engine 214 may be an HTTP web server, or it may be implemented in similar protocols such as dat, IPFS, gRPC, and the like.

The server engine 214 can listen for incoming connections from the cache client 218 (1000). When an incoming connection request from the cache client 218 is detected (1002), the server engine 214 can determine if the connection requires is a single query request or if it is a subscription request that will require a persistent connection (1004). If the request is a subscription request, the server engine 214 may parse the request to store relevant connection metadata in its own database (1006). The metadata may include the SUBSCRIPTION_QUERY_SET from FIG. 9, as well as various pieces of information that may be useful for keeping track of and servicing the connected instances of the cache client 218. Once a connection is established between the cache service 204 and the cache client 218, the cache service 204 can begin listening to cache state update events (1008). When there is a new cache state update event (e.g., from operation 910 of FIG. 9), the cache service 204 can process the event (1010) and notify the relevant connected instances of cache client 218 (1012). Then the cache service 204 can continue to listen for additional cache update events (1008).

On the other hand, if the incoming connection request 1002 is a one-off query request, the server engine 214 can query the cache storage 210 with the incoming request (1014) and return the corresponding response back to the cache client 218 (1016). The server engine 214 of the cache service 204 can then continue to listen for new connections (1000).

The blockchain query service 102 may be connected to the cache engine 200 through cache crawler 216. The cache crawler 216 can connect to the cache engine 200 and retrieve the data it wants by making a request. The request may ask for the entire contents of the cache, or it may ask for a filtered and processed version of the cache. Just like the cache engine 200, the cache crawler 216 has two modes: crawl mode and listen mode.

FIG. 11 is a flow chart of an example process for crawling the cache storage 210. The process can be performed by the cache crawler 216 during crawl mode. In crawl mode, the cache crawler 216 can construct a QUERY_SET which may define the type of data the cache crawler 216 wants to obtain from the cache engine 200 (1100). The cache crawler 216 can iterate through the QUERY_SET and make requests to the connected cache engine 200. For example, the cache crawler 216 may want to fetch all blocks from block X to Y. In such a case, the QUERY_SET may be an array of integers between X and Y: [X, X+1, X+2, . . . , Y].

To iterate through the QUERY_SET, the cache crawler 216 can set the INDEX to 0 (1102). For each iteration of INDEX, the cache crawler 216 can make a request to the cache engine 220 by using a query instruction QUERY_SET[INDEX] (1004). However, this process is not limited to multiple requests. The process may involve sending a single batch request that results in multiple responses, or even streaming requests and responses, which may be achieved through various protocols such as HTTP2. Once cache engine 200 returns the relevant response to cache client 218, the cache client 218 can process the data and send the data to the state transition engine 220. The state transition engine 220 can then use the incoming data from the cache client 218 and the contents of the state storage 112 to execute its own pre-programmed logic, and finally update the state storage 112 of the blockchain query service 102 (1106).

Once the state transition has finished, the cache crawler 216 can increment the INDEX to INDEX+1 (1108) and ensure that the entire QUERY_SET has been fully iterated through by checking whether the INDEX is greater than or equal to the length of the QUERY_SET (1110). If the INDEX is not greater than or equal to the length of the QUERY_SET, the cache crawler 216 can query the cache engine using the query instruction QUERY_SET[INDEX+1]. If, on the other hand, the INDEX is greater than the length of the QUERY_SET, the cache crawler may halt or enter listen mode.

FIG. 12 is a flow chart of an example process for listening to the cache engine 200. The process can be performed by the cache crawler 216 during listen mode. In listen mode, the cache crawler 216 does not iterate through a QUERY_SET. Instead, the cache crawler 216 can initially create a SUBSCRIPTION_QUERY_SET that defines what types of data it wants to obtain from the cache engine 200. The cache crawler 216 can send the SUBSCRIPTION_QUERY_SET to the cache engine 200, listen to the cache engine 200 for any new cache update events, and process the cache update events as they arrive.

The cache crawler 216 can construct a SUBSCRIPTION_QUERY_SET (1200). The SUBSCRIPTION_QUERY_SET may be a manually created static filter, a query language, or a programmable function. One example of a SUBSCRIPTION_QUERY_SET is a single item “ALL,” which may mean “listen to all cache update events.” Another example of a SUBSCRIPTION_QUERY_SET is one that defines a conditional filter that filters only the relevant cache update events. The cache crawler may use query languages such as Bitquery to construct the filter. Additionally or alternatively, the filter may be a map/filter function written in any programming language such as JavaScript, C, Python, Java, etc. Additionally or alternatively, the SUBSCRIPTION_QUERY_SET may comprise multiple of these query types simultaneously in order to subscribe to multiple conditions.

After constructing the SUBSCRIPTION_QUERY_SET, the cache crawler 216 can send the request to the cache engine (1202). From then on, the cache crawler 216 can listen to all the cache update events emitted by the cache engine 200 (1204). Such listening can be implemented from scratch using widely used protocols and open standards such as websockets or Server Sent Events, but also can be implemented with many existing technologies and protocols that allow for automated synchronization, such as Apache Kafka, ZeroMQ, RabbitMQ, Redis, MongoDB replication, and more. When a new event occurs, the cache engine 200 can emit a cache update event, as described in step 1012 of FIG. 10. The cache crawler 216 can detect this (1206), and the cache client 218 may make an additional crawl request to the cache engine 200 to fetch the updated content, then pass the response to the state transition engine 220, which may then use the incoming data and the contents of the state storage 112 to programmatically make a state transition on the state storage 112 (1208). After this state transition, the cycle goes back to step 1204 and the event loop continues, where the cache crawler 216 continues to listen to the connected cache engine events (1204). In another embodiment, the cache update event emitted from the cache engine 200 may contain a full payload of the required data and the cache crawler 216 may pass this data directly to the state transition engine 220, bypassing the need for an additional crawl step.

The QUERY_SET of FIG. 11 and the SUBSCRIPTION_QUERY_SET of FIG. 12 may be constructed based on a request from the application 116. In some cases, desired data may not be available in the cache storage 210. In such cases, the blockchain crawler 202 can obtain such data from the blockchain 100 and write it to the cache storage 210 via state transition engine 208.

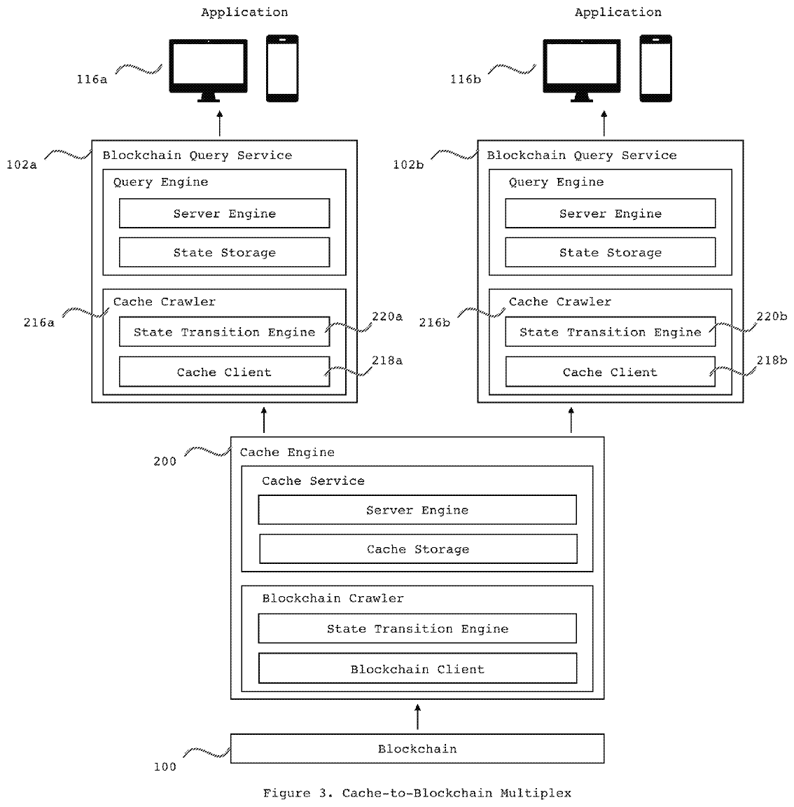

In some embodiments (FIG. 3), one cache engine 200 may serve multiple blockchain query services 102a and 102b. The blockchain query services 102a and 102b can then provide data to applications 116a and 116b, respectively. In this configuration, the application 116a can connect to blockchain query service 102a to obtain data. The blockchain query service 102a may contain a cache crawler 216a. The cache crawler 216a may contain a cache client 218a and a state transition engine 220a. The cache client 218a can connect to the cache engine 200 to request data. Likewise, the application 116b can connect to the blockchain query service 102b. The blockchain query service 102b may contain cache crawler 216b. The cache crawler 216b may contain a state transition engine 220b and a cache client 218b. The cache client 218b can connect to the cache engine 200 to request data. This way, both blockchain query services 102a and 102b can connect to the single shared cache engine 200 instead of connecting directly to the blockchain 100. Although FIG. 3 depicts only two blockchain query services, many such services can simultaneously connect to the cache engine 200. The configuration of FIG. 3 may reduce the number of connections to the blockchain, which may reduce network bandwidth requirements and the likelihood of the blockchain crashing.

In some embodiments (FIG. 4), one cache engine may implement a replication service. The cache engine 200c may act as the seed cache engine, i.e., the cache engine that connects directly to blockchain 100. Once the cache engine 200c is populated, it can provide its service to other cache engines. In this scenario, the cache engines 200d and 200e may have cache crawlers 216d and 216e that connect to the seed cache engine 200c through cache clients 218d and 218e, respectively. The cache clients 218d and 218e can send requests to the cache engine 200c to replicate the entire contents of the cache storage of cache engine 200c. Alternatively, the cache clients 218d and 218e may request only a subset of the contents of the cache storage of the cache engine 200c. Then, the cache clients 218d and 218e can send the data to the state transition engines 220d and 220e, respectively. The cache engines 200d and 200e can expose themselves for connection, and blockchain query services 102d and 102e may connect to the cache engines to obtain their data. The configuration of FIG. 4 may improve the speed with which applications can access blockchain data, because such applications can interface with multiple blockchain query services and multiple cache engines in parallel.

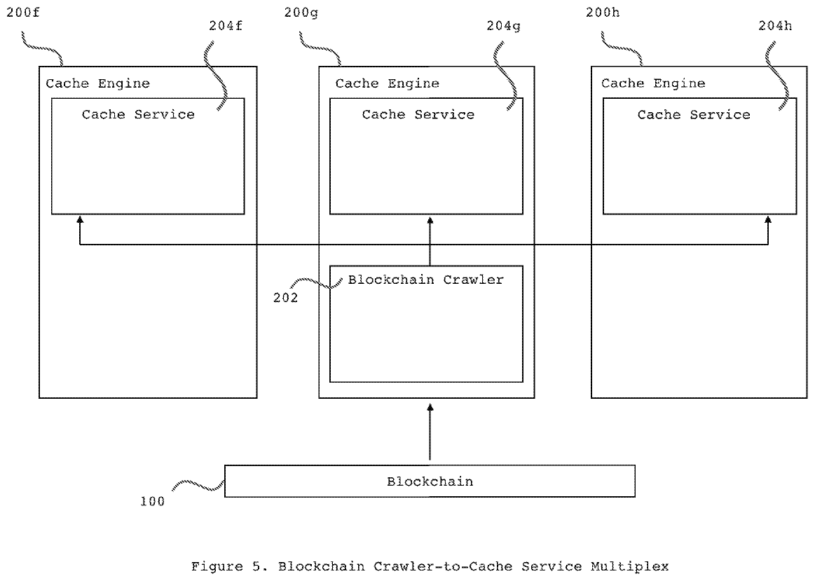

In some embodiments (FIG. 5), a blockchain crawler 202 can send data to cache services 204f, 204g, and 204h in cache engines 200f, 200g, and 200h, respectively, while the blockchain crawler 202 crawls the blockchain. The cache engines 200f and 200h may lack their own blockchain crawlers. Instead, the blockchain crawler 202 of cache engine 202g can broadcast the data it obtains from the blockchain to all of the cache engines 200f, 200g, and 200h. This may provide similar advantages as the configuration of FIG. 4.

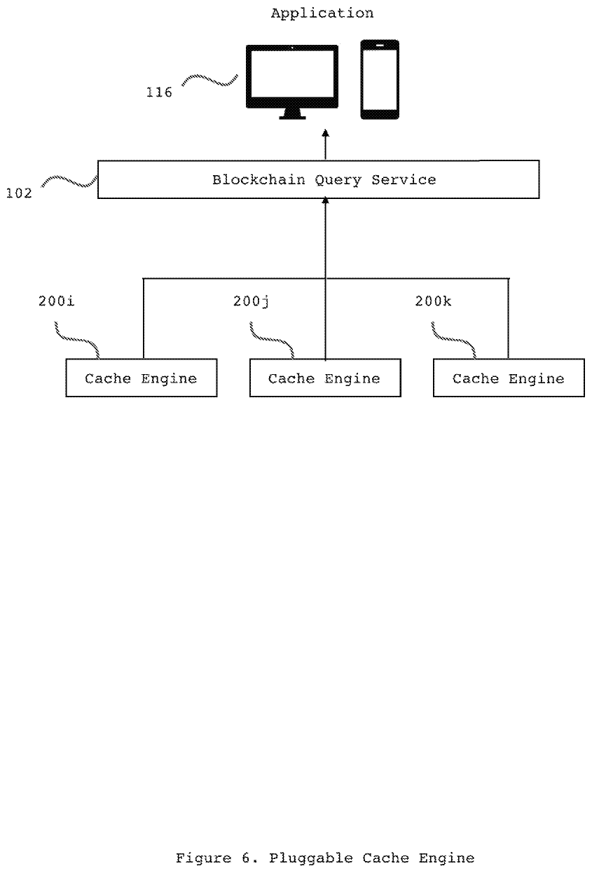

In some embodiments (FIG. 6), a blockchain query service 102 can obtain data from multiple cache engines 200i, 200j, and 200k. The blockchain query service 102 can connect to cache engine 200i, 200j, and 200k in any combination. For example, the blockchain query service 102 can connect to cache engines 200i, 200j, and 200k. Or it can connect to cache engine 200i under normal circumstances but connect to cache engine 200j or 200k when cache engine 200i becomes unavailable. Or it may connect and read from all of cache engines 200i, 200, and 200k to obtain data from them simultaneously. The blockchain query service 102 can cross-validate such data. The cache engines 200i, 200j, and 200k can store and serve the same data, or they can store and serve different data (e.g., different portions of the blockchain). Although FIG. 6 depicts only three cache engines, the blockchain query service 102 can connect to many cache engines.

The embodiments described in FIGS. 3-6 may be integrated together in any combination. For example, multiple cache engines can connect to a single blockchain as in FIG. 5. Each of the multiple cache engines can then connect to multiple blockchain query services as in FIG. 3, or to multiple other cache engines as in FIG. 4. Additionally, the quantity of blockchain services and cache engines in any of FIGS. 3-6 may be smaller or much larger. For example, the quantity of cache engines in the embodiment of FIG. 6 may be about 1, 2, 3, 5, 10, 20, 50, 100, 1000, or more.

The blocks in FIGS. 2-6 do not necessarily correspond to individual physical machines (e.g., computers). For example, in FIG. 2, the blockchain query service component 102 and the cache engine 200 may be implemented on the same machine, or they may be implemented on different machines. The server engine 114 may or may not be on the same machine as the state storage 112. The state transition engine 220 and the cache client 218 may or may not be on the same machine. The server engine 214 and the cache storage 210 may or may not be on the same machine. And the state transition engine 208 and the blockchain client 206 may or may not be on the same machine. Also, the blockchain 100 itself may or may not be on the same machine as the rest of the components. All of these components can be implemented as a microservice and distributed over multiple host computers that communicate with each other over a network using any of the methods described herein.

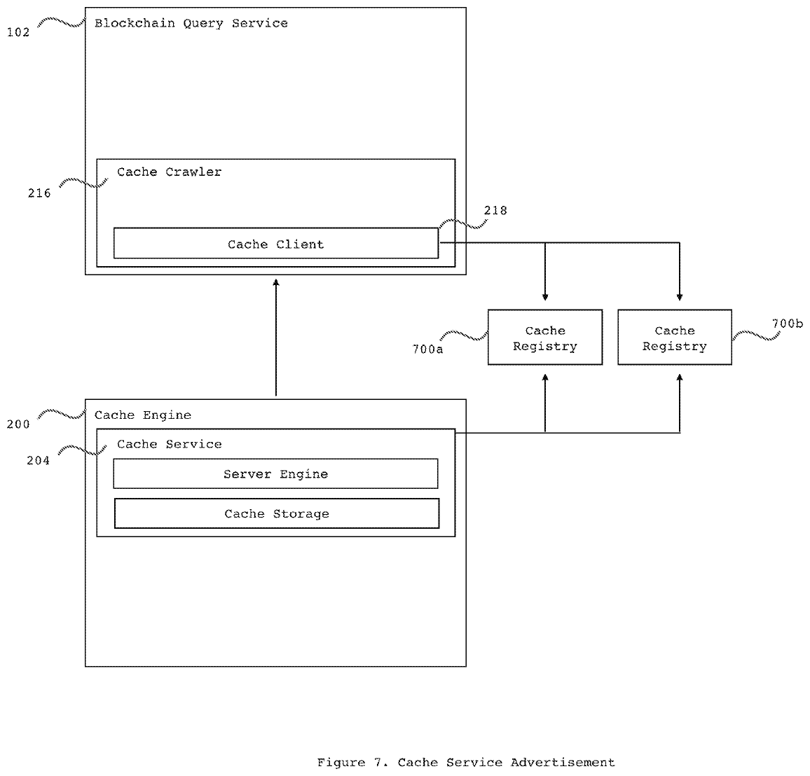

In some embodiments, the cache engine may advertise itself to a cache registry to allow for discovery from various cache clients. In FIG. 7, a cache service 204 of a cache engine 200 can advertise itself to cache registries 700a and 700b by making a request with uniquely identifiable information as well as metadata of what type of cache service it is providing. Then the cache client 218 may discover the cache engine 200 through looking up the cache registries 700a and 700b, and once discovered connect to the cache engine. The cache registries 700a and 700b may take different forms. For example, they may be stored on a central server with a database. Alternatively, the cache registry can be a distributed hash table. In another embodiment, FIG. 7 may be implemented in a reverse manner in which the cache client 218 advertises itself to the cache registries and the cache service 204 discovers the cache client 218, after which cache service 204 can connect to the cache client. This can enable cache clients to discover previously unknown cache services, and vice versa.

In some embodiments, the cache service 204 may maintain an additional database to manage incoming connections from cache client 218. The cache client 218 may make certain requests containing certain metadata, and the cache service 204 may store the metadata for each client. This may include information required to deliver customized responses to each client for every request, or for delivering customized events during cache crawler listen mode (FIG. 12), or to manage a session to remember the cache client.

In some embodiments, the cache system may function not based on a request-response pattern but based on persistent synchronization. For example, in FIG. 2, the cache client 218 may not proactively request data from the cache service 204, but instead exist as a replication instance of the cache storage 210. This may be achieved through various data replication methods supported by many storage systems and protocols such as MongoDB, CouchDB, Apache Kafka, DAT, and IPFS. The cache storage 210 may implement one of such replication methods and function as a master instance, and the various implementations of cache client 218 may embed a follower replication instance that replicates the cache storage 210. Then, as the cache client 218 synchronizes to a new state, it may send the new updates to the state transition engine 220, which then process and update the state storage 112. Alternatively, the state storage 112 itself may be implemented as a follower replication instance of the cache storage 210, in which case the state storage 112 can skip the cache client 218 and the state transition engine of 220 and directly update the storage.

In some embodiments, the cache crawler 216 may request a complete set of a full block data, which may include not only all the raw transactions in a block, but also the merkle root of the block, which the cache client 218 may use to verify the authenticity of the rest of the data without having to trust the cache engine provider.

In some embodiments, the events can be emulated as frequent polling instead. For example, instead of listening to events from cache engines, the cache clients may constantly poll the cache engine for an update.

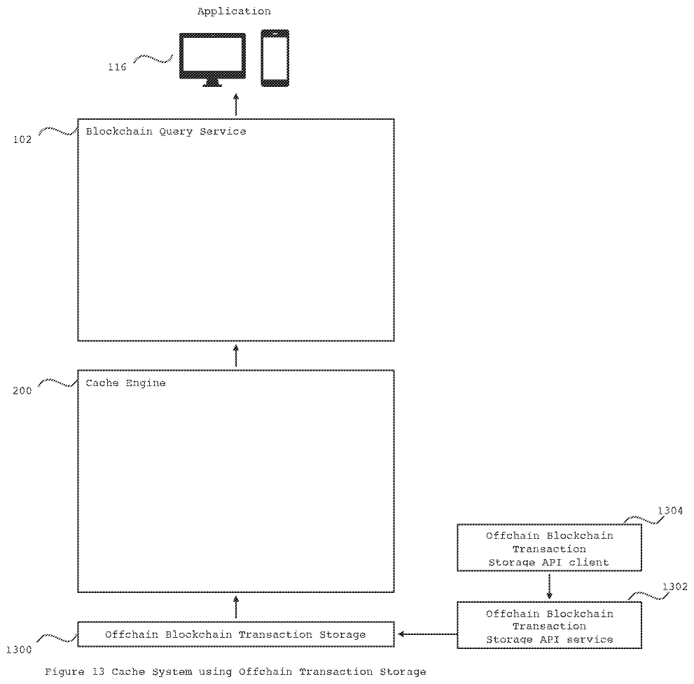

In some embodiments (FIG. 13), the blockchain 100 may be replaced by an offchain blockchain transaction storage 1300. The offchain transaction storage 1300 may be a storage system which stores signed or unsigned blockchain transactions outside of the blockchain. The offchain blockchain transaction storage 1300 may be a storage system maintained by a user of the blockchain, or it may be a storage system maintained by an entity that writes transactions to the blockchain on behalf of the end user (e.g., for a fee). An offchain transaction storage may be used by end users for temporarily storing transactions before they broadcast them to the blockchain peer network, or send directly to blockchain miners. An offchain transaction storage may also be used by blockchain miners to directly accept transactions from users before broadcasting. An offchain transaction storage may be used by blockchain miners to directly accept transaction submissions from users to potentially include them in a block in the future when they mine a block. And it can be used for many other purposes. The offchain blockchain transaction storage 1300 may be connected to offchain blockchain transaction storage API service 1302. An offchain blockchain transaction storage API client 1304 may send a blockchain transaction to the API service 1302. The API service 1302 can then store it to the offchain blockchain transaction storage 1300. In this case, the cache engine 200 can crawl and listen to this offchain blockchain transaction storage 1300 instead of the blockchain 100, but the rest of the architecture may be the same. The offchain blockchain transaction storage 1300 may be optimized for storing, but not reading or filtering. For example, the offchain transaction storage 1300 may be implemented as an append-only log structure using systems such as Apache Kafka, or it may be implemented as simply a raw dump into a file system. The offchain blockchain transaction storage 1300 may ensure that the stored transactions can be retrieved later but may not be designed to provide a flexible and powerful index and query interface. As such, the cache engine 200 can provide the same type of value add as crawling the blockchain 100.

### Computer Systems

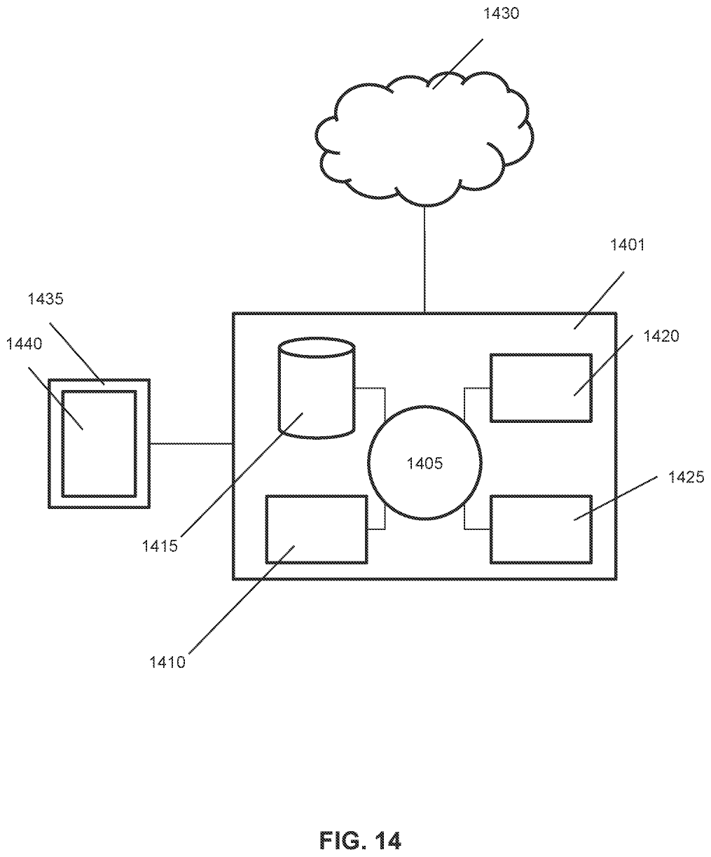

The present disclosure provides computer systems that are programmed to implement methods of the disclosure. FIG. 14 shows a computer system 1401 that is programmed or otherwise configured to implement the blockchain query service 102 or the cache engine 200 of FIG. 2, or perform the processes of FIGS. 8-12.

The computer system 1401 includes a central processing unit (CPU, also “processor” and “computer processor” herein) 1405, which can be a single core or multi core processor, or a plurality of processors for parallel processing. The computer system 1401 also includes memory or memory location 1410 (e.g., random-access memory, read-only memory, flash memory), electronic storage unit 1415 (e.g., hard disk), communication interface 1420 (e.g., network adapter) for communicating with one or more other systems, and peripheral devices 1425, such as cache, other memory, data storage and/or electronic display adapters. The memory 1410, storage unit 1415, interface 1420 and peripheral devices 1425 are in communication with the CPU 1405 through a communication bus (solid lines), such as a motherboard. The storage unit 1415 can be a data storage unit (or data repository) for storing data. The computer system 1401 can be operatively coupled to a computer network (“network”) 1430 with the aid of the communication interface 1420. The network 1430 can be the Internet, an internet and/or extranet, or an intranet and/or extranet that is in communication with the Internet. The network 1430 in some cases is a telecommunication and/or data network. The network 1430 can include one or more computer servers, which can enable distributed computing, such as cloud computing. The network 1430, in some cases with the aid of the computer system 1401, can implement a peer-to-peer network, which may enable devices coupled to the computer system 1401 to behave as a client or a server.

The CPU 1405 can execute a sequence of machine-readable instructions, which can be embodied in a program or software. The instructions may be stored in a memory location, such as the memory 1410. The instructions can be directed to the CPU 1405, which can subsequently program or otherwise configure the CPU 1405 to implement methods of the present disclosure. Examples of operations performed by the CPU 1405 can include fetch, decode, execute, and writeback.

The CPU 1405 can be part of a circuit, such as an integrated circuit. One or more other components of the system 1401 can be included in the circuit. In some cases, the circuit is an application specific integrated circuit (ASIC).

The storage unit 1415 can store files, such as drivers, libraries and saved programs. The storage unit 1415 can store user data, e.g., user preferences and user programs. The computer system 1401 in some cases can include one or more additional data storage units that are external to the computer system 1401, such as located on a remote server that is in communication with the computer system 1401 through an intranet or the Internet.

The computer system 1401 can communicate with one or more remote computer systems through the network 1430. For instance, the computer system 1401 can communicate with a remote computer system of a user (e.g., a computer on which the application 116 is implemented). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 1401 via the network 1430.

Methods as described herein can be implemented by way of machine (e.g., computer processor) executable code stored on an electronic storage location of the computer system 1401, such as, for example, on the memory 1410 or electronic storage unit 1415. The machine executable or machine-readable code can be provided in the form of software. During use, the code can be executed by the processor 1405. In some cases, the code can be retrieved from the storage unit 1415 and stored on the memory 1410 for ready access by the processor 1405. In some situations, the electronic storage unit 1415 can be precluded, and machine-executable instructions are stored on memory 1410.

The code can be pre-compiled and configured for use with a machine having a processer adapted to execute the code or can be compiled during runtime. The code can be supplied in a programming language that can be selected to enable the code to execute in a pre-compiled or as-compiled fashion.

Aspects of the systems and methods provided herein, such as the computer system 1401, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 1401 can include or be in communication with an electronic display 1435 that comprises a user interface (UI) 1440 for providing, for example, any of the APIs or applications (e.g., application 116) described herein. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 1405. The algorithm can, for example, an algorithm that implements a blockchain crawl mode as in FIG. 8 or a blockchain listening mode as in FIG. 9.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1.-62. (canceled)

63. A system for obtaining data from a blockchain, comprising:
a cache engine comprising cache storage and a blockchain crawler, wherein said blockchain crawler is configured to obtain blockchain data from said blockchain and write a subset of said blockchain data to said cache storage or update a state of said cache storage based on said subset of said blockchain data, wherein said subset of said blockchain data satisfies a query generated by said cache engine; and
a blockchain query service communicatively coupled to said cache engine, wherein said blockchain query service comprises state storage and a cache crawler, wherein said cache crawler is configured to obtain cache data from said cache storage and update a state of said state storage based at least on said cache data.

64. The system of claim 63, wherein said cache storage is configured to store at most a subset of the entire contents of said blockchain.

65. The system of claim 64, wherein said cache engine is configured to prune blockchain data from said cache storage that corresponds to transactions that occurred outside a specified time frame.

66. The system of claim 63, further comprising a plurality of additional cache engines, wherein said plurality of additional cache engines do not comprise a blockchain crawler, and wherein said blockchain crawler of said cache engine is configured to write said subset of said blockchain data to said plurality of additional cache engines.

67. The system of claim 66, wherein each of said plurality of additional cache engines is communicatively coupled to at least one additional blockchain query service.

68. The system of claim 63, further comprising an additional cache engine, wherein said blockchain query service is communicatively coupled to said additional cache engine.

69. The system of claim 68, wherein said additional cache engine comprises an additional cache storage, and wherein said cache storage and said additional cache storage store the same data.

70. The system of claim 68, wherein said additional cache engine comprises an additional cache storage, and wherein said cache storage and said additional cache storage store different data.

71. The system of claim 63, further comprising a cache registry communicatively coupled to said cache engine and configured to store metadata about said cache engine, wherein said metadata about said cache engine is accessible by a plurality of blockchain query services including said blockchain query service.

72. The system of claim 71, wherein said metadata comprises a unique identifier of said cache engine.

73. A method for obtaining blockchain data, comprising:
(a) providing a blockchain system comprising (i) a cache engine comprising cache storage and a blockchain crawler and (ii) a blockchain query service communicatively coupled to said cache engine, wherein said blockchain query service comprises state storage and a cache crawler;
(b) using said blockchain crawler to obtain blockchain data from said blockchain and write a subset of said blockchain data to said cache storage or update a state of said cache storage based on said subset of said blockchain data, wherein said subset of said blockchain data satisfies a query generated by said cache engine; and
(c) using said cache crawler to obtain cache data from said cache storage and update a state of said state storage based at least on said cache data.

74. The method of claim 73, wherein said cache storage is configured to store at most a subset of the entire contents of said blockchain.

75. The method of claim 74, further comprising pruning blockchain data from said cache storage that corresponds to transactions that occurred outside a specified time frame.

76. The method of claim 73, further comprising providing a plurality of additional cache engines, wherein said plurality of additional cache engines do not comprise a blockchain crawler; and writing, using said blockchain crawler of said cache engine, said subset of said blockchain data to said plurality of additional cache engines.

77. The method of claim 76, wherein each of said plurality of additional cache engines is communicatively coupled to at least one additional blockchain query service.

78. The method of claim 73, further comprising providing an additional cache engine, wherein said blockchain query service is communicatively coupled to said additional cache engine.

79. The method of claim 78, wherein said additional cache engine comprises an additional cache storage, and wherein said cache storage and said additional cache storage store the same data.

80. The method of claim 78, wherein said additional cache engine comprises an additional cache storage, and wherein said cache storage and said additional cache storage store different data.

81. The method of claim 73, further comprising providing a cache registry, wherein said cache registry is communicatively coupled to said cache engine; and storing metadata about said cache engine in said cache registry, wherein said metadata about said cache engine is accessible by a plurality of blockchain query services including said blockchain query service.

82. The method of claim 81, wherein said metadata comprises a unique identifier of said cache engine.
